(19) United States
(12) Patent Application Publication
(10) Pub. No.: US 2013/0076094 A1
(43) Pub. Date: Mar. 28, 2013

(54) RECLINING APPARATUS

(71) Applicants: Yoshitaka ISHIHARA, Aichi (JP); Kazuyoshi HARA, Aichi (JP)

(72) Inventors: Yoshitaka ISHIHARA, Aichi (JP); Kazuyoshi HARA, Aichi (JP)

(73) Assignee: IMASEN ELECTRIC INDUSTRIAL CO., LTD., Aichi (JP)

(21) Appl. No.: 13/245,917

(22) Filed: Sep. 27, 2011

(51) Int. Cl. B60N 2/20; B60N 2/44

(52) U.S. Cl. 297/354.1; 74/412 R

(57) ABSTRACT

A reclining apparatus for adjusting a tilt angle between a first member and a second member includes: a base plate mounted to the first member; a gear plate mounted to the second member and assembled with the base plate rotatably relative to each other; a gear mechanism for controlling engagement of the gear plate with the base plate; and a cover having a first tubular portion fixed to an outer periphery of the base plate and a second tubular portion in slide contact with an outer periphery of the gear plate, the cover being configured to allow the base plate and the gear plate to rotate relative to each other and to suppress a relative movement therebetween in an axial direction. The first tubular portion is coupled by welding to the outer periphery of the base plate.

### CROSS-REFERENCE TO RELATED APPLICATION

This application is based on Japanese Patent Application No. 2010-147222 filed with the Japan Patent Office on Jun. 29, 2010, the entire content of which is hereby incorporated by reference.

### BACKGROUND

1. Technical Field

This disclosure relates to a reclining apparatus that adjusts a tilt angle between a first member and a second member.

2. Related Art

Known reclining apparatuses for adjusting a tilt angle between a first member and a second member include a reclining apparatus 120 for a vehicle seat as illustrated in FIG. 6. In the reclining apparatus 120, a base plate 130 and a gear plate 140 rotate relative to each other. A cover 150 regulates a relative movement between the base plate 130 and the gear plate 140 in an axial direction. A held portion 131 is formed at an outer peripheral portion of the base plate 130. The held portion 131 is used to fix the cover 150 to the base plate 130. The cover 150 holds the held portion 131 in the axial direction. In this structure, the radial dimension of the reclining apparatus 120 is increased by the amount corresponding to the held portion 131. Note that FIG. 6 illustrates an internal gear 141 of the gear plate 140, a lock gear 160, an external gear 161 of the lock gear, and a cam 170. The cam 170 controls meshing of the internal gear 141 with the external gear 161.

In a vehicle seat reclining apparatus disclosed in JP-A-2008-018108, a machine casing (base plate) and a cover member (gear plate) are rotatably retained relative to each other in the state where a relative movement therebetween in the axial direction is regulated by a regulating member (cover). In the regulating member, an end of a large-diameter portion of a cylindrical regulating portion surrounding the outside of the machine casing in the radial direction is coupled by welding to an outer peripheral portion of the machine casing. Specifically, an outer peripheral edge of the machine casing is formed into an R-shape. As a result, a circular groove is formed between an end face of the machine casing and an end face of the regulating member. The end face of the machine casing and the end face of the regulating member are coupled together by welding so as to form a welding bead in the circular groove. In this structure, the outer diameter of the reclining apparatus is reduced as compared with the structure in which the machine casing is provided with the held portion.

### SUMMARY

A reclining apparatus for adjusting a tilt angle between a first member and a second member according to one or two embodiments includes: a base plate mounted to the first member; a gear plate mounted to the second member and assembled with the base plate rotatably relative to each other; a gear mechanism for controlling engagement of the gear plate with the base plate; and a cover having a first tubular portion fixed to an outer periphery of the base plate and a second tubular portion in slide contact with an outer periphery of the gear plate, the cover being configured to allow the base plate and the gear plate to rotate relative to each other and to suppress a relative movement therebetween in an axial direction. The first tubular portion is coupled by welding to the outer periphery of the base plate.

### BRIEF DESCRIPTION OF THE DRAWINGS

FIG. 1 is a side view depicting an overall structure of a vehicle seat installed with a reclining apparatus of an embodiment;

FIG. 2 is a sectional view of the reclining apparatus;

FIG. 3 is a sectional view taken along the line 3-3 of FIG. 2;

FIG. 4 is a sectional view taken along the line 4-4 of FIG. 2;

FIG. 5 is an enlarged sectional view depicting an assembled state of a base plate and a cover bracket; and

FIG. 6 is a sectional view showing a reclining apparatus of a related art.

### DESCRIPTION OF EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

When an end face of a base plate and an end face of a cover are simply coupled together by welding as in the reclining apparatus disclosed in JP-A-2008-018108, a part of the end face of the base plate rises due to a welded portion. If the base plate is assembled with a bracket provided on the seat side through the end face, the welded portion is positioned between the base plate and the bracket. This causes backlash between the base plate and the bracket. To eliminate the backlash, for example, a cutting process for removing the welded portion may be performed on the end face. In this case, however, the addition of a new process step hinders a reduction in cost of the reclining apparatus.

An object of this disclosure is to provide a compact reclining apparatus with a small radial dimension.

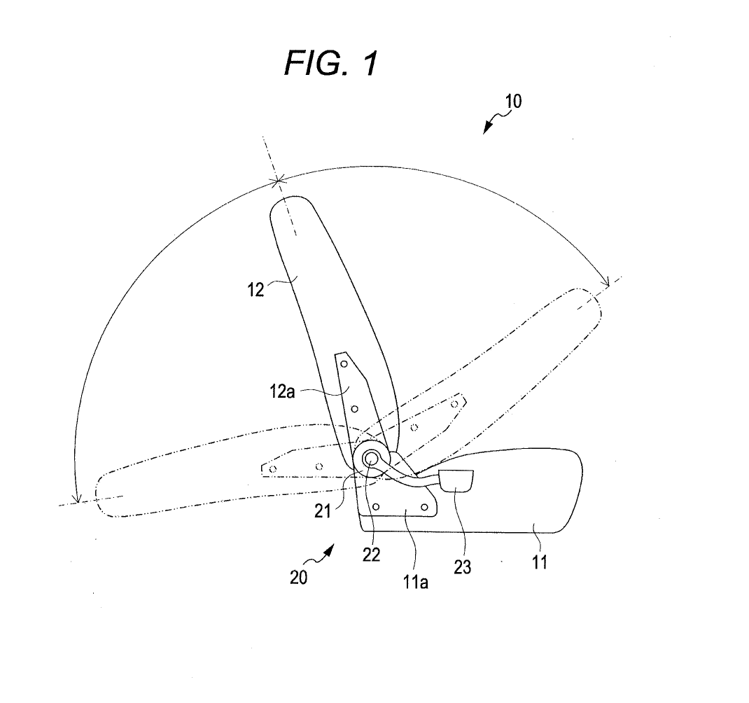

Hereinafter, a reclining apparatus 20 according to an embodiment of the present embodiment is described with reference to the drawings. FIG. 1 is a side view depicting an overall configuration of a vehicle seat 10 installed with the reclining apparatus 20.

The vehicle seat 10 includes a seat cushion 11, a seat back 12, and the reclining apparatus 20. A seat bracket (lower bracket) 11 a is fixed to the seat cushion 11. A seat back bracket (upper bracket) 12a is fixed to the seat back 12.

The lower bracket 11 a and the upper bracket 12a are respectively fixed to two portions of the reclining apparatus 20 (round reclining unit 21), and the two portions are rotatable relative to each other. Thus, the lower bracket 11a and the upper bracket 12a are rotatably coupled relative to each other. This structure allows for adjustment of a tilt angle of the seat back 12 with respect to the seat cushion 11. The seat cushion 11 and the lower bracket 11a may be an example of the “first member” set forth in the claims. The seat back 12 and the upper bracket 12a may be an example of the “second member” set forth in the claims.

The reclining apparatus 20 includes the round reclining unit 21, a center shaft 22, and a reclining manipulation lever 23. The reclining manipulation lever 23 is attached to the central shaft 22 that is disposed at the center of the round reclining unit 21. When the reclining manipulation lever 23 is pulled upward, the reclining apparatus 20 is brought into an unlocked state. In the unlocked state, the tilt angle of the seat back 12 becomes adjustable. As is seen from FIG. 1, the seat back 12 is rotatable in a range from a forward tilted position at which the seat back 12 is in contact with the seat cushion 11 to a backward tilted position at which the seat back 12 is flush with the seat cushion 11. Such a structure of the reclining apparatus 20 is described in detail below.

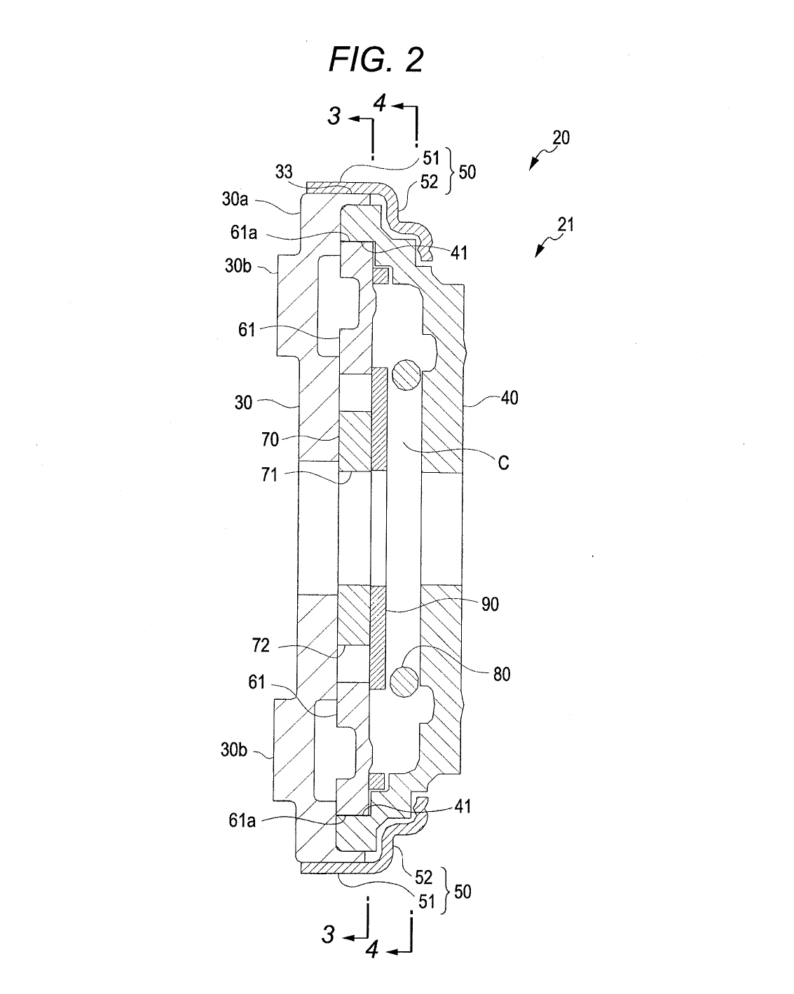

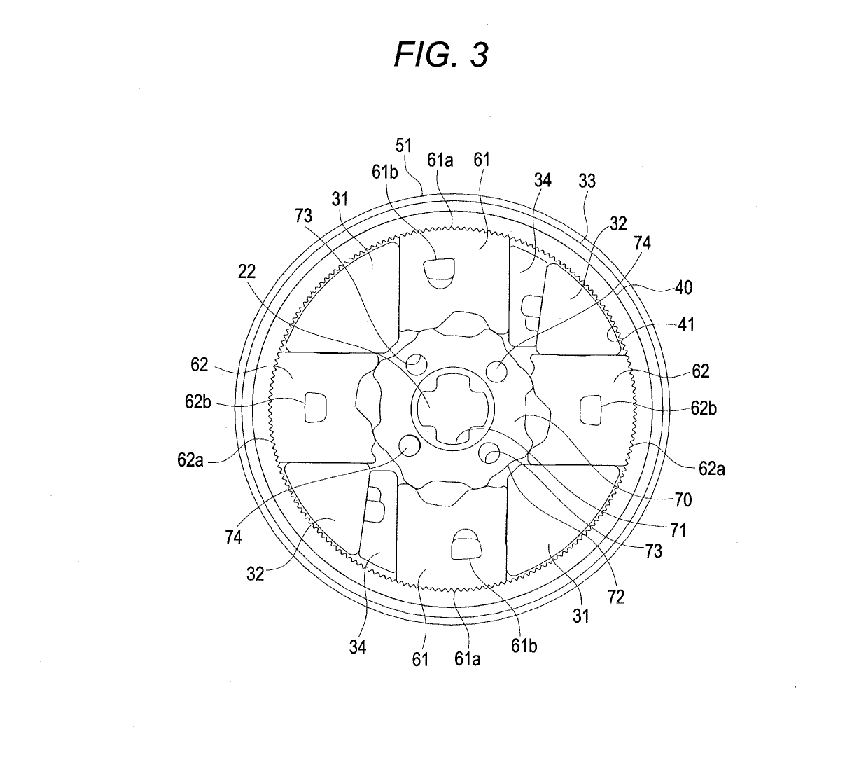

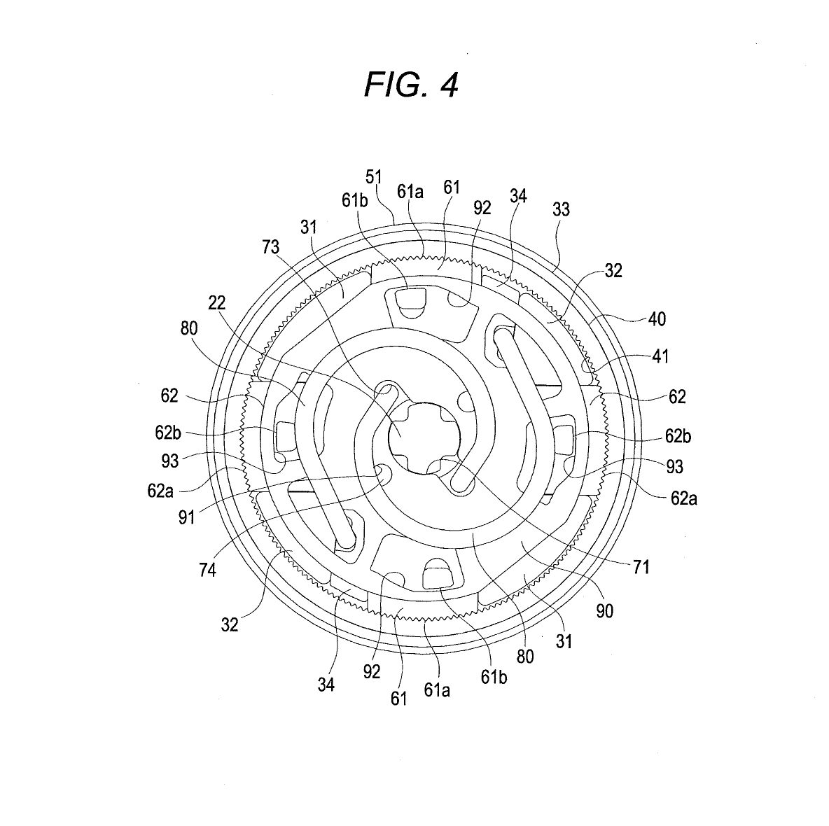

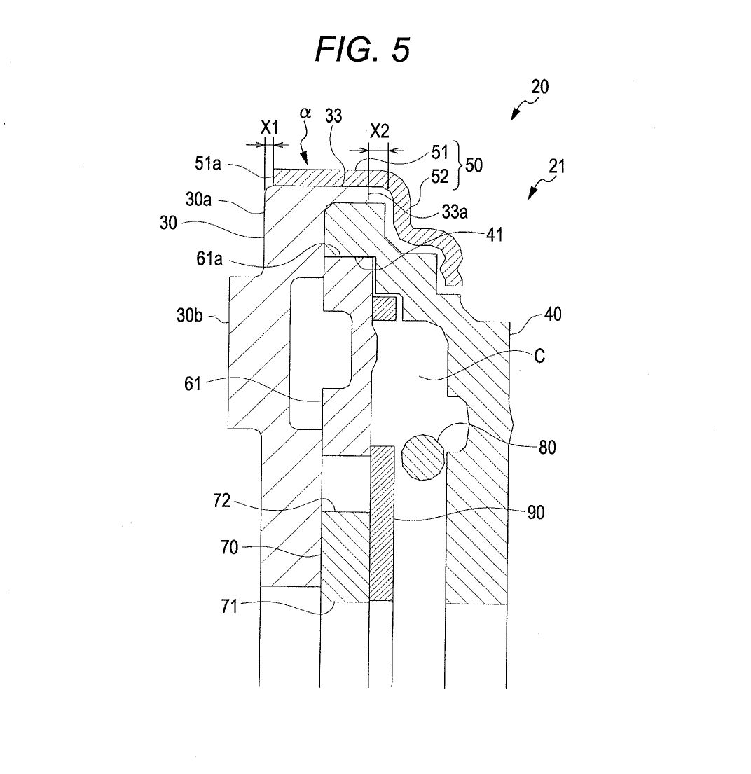

FIG. 2 is a sectional view of the reclining apparatus 20. FIG. 3 is a sectional view taken along the line 3-3 of FIG. 2. FIG. 4 is a sectional view taken along the line 4-4 of FIG. 2. FIG. 5 is an enlarged sectional view depicting an assembled state of a base plate 30 and a cover bracket 50. Note that, in FIG. 2, the center shaft 22 and the reclining manipulation lever 23 are not illustrated for ease of understanding. In FIG. 4, portions of a gear plate 40 other than portions in the vicinity of internal gears 41 are not illustrated.

As depicted in FIG. 2, the round reclining unit 21 includes the base plate 30 having a substantially disc shape, the gear plate 40 having a substantially bowl shape, and the cover bracket 50. The base plate 30 and the gear plate 40 overlap each other. The cover bracket 50 is assembled with the base plate 30 and the gear plate 40 overlapping each other. This structure allows the base plate 30 and the gear plate 40 to rotate relative to each other and to suppress a relative movement therebetween in an axial direction.

The term “axial direction” used herein refers to a direction along the axis of the center shaft 22.

A cavity (space) C is formed between the base plate 30 and the gear plate 40. As depicted in FIGS. 2 to 4, for example, four lock gears including a pair of first lock gears 61 and a pair of second lock gears 62, a central cam 70, two spring members 80 having a substantially circular shape, a lever plate 90 having a substantially disc shape are disposed in the cavity C. These are members for bringing the reclining apparatus 20 into a locked state or an unlocked state. In other words, these members serve as a gear mechanism for the reclining apparatus 20 for controlling engagement of the gear plate 40 with the base plate 30.

Hereinafter, the left side of FIG. 2 is referred to as “a first side in the axial direction,” and the right side of FIG. 2 is referred to as “a second side in the axial direction.” The back surface of the base plate 30 (hereinafter also referred to as a mounting surface 30a on the first side in the axial direction) has a plurality of projections 30b formed thereon. The projections 30b are engaged into respective engagement holes (not shown) in the lower bracket 11a. Thus, the base plate 30 is mounted on the lower bracket 11a through the mounting surface 30a. As depicted in FIG. 3, two pairs of guide protrusions (four in total) 31 and 32 are formed on a side surface of the base plate 30 on the second side in the axial direction to guide the lock gears 61 and 62 in the radial direction. The guide protrusions 31 and 32 may be examples of the “guide portion” set forth in the claims.

An annular protruding portion 33 that protrudes toward the second side in the axial direction is formed at an outer edge of the base plate 30. The annular protruding portion 33 is formed such that the inner peripheral surface thereof is engageable with a part of the outer peripheral surface of the gear plate 40. For example, the guide protrusions 31 and 32 of the base plate 30 may be formed by plastic working such as press working. The annular protruding portion 33 may be formed by ironing (plastic working).

The internal gears 41 are formed over the entire perimeter of the inner peripheral surface of the gear plate 40. A plurality of projections (not shown) is formed on the back surface (surface on the second side in the axial direction) of the gear plate 40. The projections are engaged into respective engagement holes (not shown) in the upper bracket 12a, thereby mounting the gear plate 40 to the upper bracket 12a.

As shown in FIG. 3, external gears 61a are formed on the outer periphery of the first lock gears 61. External gears 62a are formed on the outer periphery of the second lock gears 62. The external gears 61a and 62a are meshable with the internal gears 41 of the gear plate 40. Projections 61b are formed on the first lock gears 61. Projections 62b formed are formed on the second lock gears 62. The projections 61b and 62b project toward the second side in the axial direction. The first lock gears 61 are supported such that they are allowed to be guided to a linear portion (guide portion) at side peripheral portions of movable guides 34 and the guide protrusions 31 and are slidable in the radial direction. The movable guides 34 are guided to the guide protrusions 32. The second lock gears 62 are supported such that they are allowed to be guided to a guide portion at side peripheral portions of the guide protrusions 31 and 32 and to be slidable in the radial direction.

The plate-shaped cam 70 is rotatably disposed at the center of the base plate 30. A through-hole 71 is formed at the center of the cam 70. A cam surface 72 is formed on the outer peripheral surface of the cam 70. The cam surface 72 comes into contact with rear end faces of the lock gears 61 and 62. Two engagement holes 73 and two columnar projections 74 are formed at side surfaces of the cam 70. The engagement holes 73 accept first ends of the spring members 80, respectively. The projections 74 project toward the second side in the axial direction.

As depicted in FIG. 4, the cam 70 is engaged with first ends of the two spring members 80. Thus, the cam 70 is strongly biased in a locking rotation direction (clockwise direction in FIGS. 3 and 4). This brings the cam 70 into contact with the rear end faces of the lock gears 61 and 62 through the cam surface 72. As a result, the cam 70 allows the lock gears 61 and 62 to be strongly outwardly biased in the radial direction by biasing force in the locking rotation direction of the spring members 80. Second ends of the spring members 80 penetrate the through-holes in the corresponding movable guides 34 and are engaged with the base plate 30.

The center shaft 22 is inserted into the through-hole 71 in the cam 70. The center shaft 22 is rotated to allow the cam 70 to rotate in an unlocking rotation direction (counterclockwise direction in FIGS. 3 and 4) against the biasing force of the spring members 80.

As depicted in FIG. 4, the lever plate 90 is provided with two through-holes 91 for fitting in the projections 74 of the cam 70. The lever plate is also provided with two cam holes 92 and two cam holes 93. The lever plate 90 is assembled with the cam 70 and the lock gears 61 and 62 such that the projections 74 are fit into the corresponding through-holes 91; the projections 61b are inserted into the corresponding cam holes 92; and the projections 62b are inserted into the corresponding cam holes 93.

In this structure, when the lever plate 90 rotates in the unlocking rotation direction together with the cam 70, the inner peripheral edges of the two cam holes 92 come into contact with the corresponding projections 61b of the first lock gears 61. Further, the inner peripheral edges of the two cam holes 93 come into contact with the corresponding projections 62b of the second lock gears 62. On the other hand, when the lever plate 90 rotates in the unlocking rotation direction, the projections 61b and the projections 62b are inwardly biased in the radial direction by the inner peripheral edges of the corresponding cam holes 92 or 93. This allows the lock gears 61 and 62 to inwardly move in the radial direction.

As depicted in FIG. 5, the cover bracket 50 includes a first tubular portion 51 having a cylindrical shape and a second tubular portion 52 having a stepped cylindrical shape. The first tubular portion 51 contacts the outer peripheral surface of the base plate 30 through the inner peripheral surface in the state where the cover bracket 50 is fit to the base plate 30. An end face of the first tubular portion 51 51a, which is an end face on the side of the base plate 30 on the first side in the axial direction, is located closer to the second side in the axial direction than the mounting surface 30a. In other words, a gap X1 (first gap) is axially formed between the end face 51a and the mounting surface 30a.

In the state where the cover bracket 50 is fixed to the base plate 30, the second tubular portion 52 is in slide contact with, for example, the outer peripheral surface and the side surface in the vicinity of the outer edge of the gear plate 40 on the second side in the axial direction through the inner peripheral surface of the second tubular portion 52. On the other hand, the second tubular portion 52 is not in contact with an end face 33a of the annular protruding portion 33, which is a leading end thereof, on the second side in the axial direction. In other words, a gap X2 (second gap) depicted in FIG. 5 is axially formed between the inner peripheral surface of the second tubular portion 52 and the end face 33a of the annular protruding portion 33. Thus, the gap X2 is formed between the end face 33a and the second tubular portion 52. In this structure, the dimensional accuracy desired for the annular protruding portion 33 is lowered as compared with a structure in which the cover bracket 50 is fixed to the base plate 30 in the state where the end face 33a is brought into contact with the second tubular portion 52.

In the manner as described above, the base plate 30 and the gear plate 40 are integrally assembled to form the cavity C therebetween. The lock gears 61 and 62 and the cam 70, for example, are disposed in the cavity C. The first tubular portion 51 of the cover bracket 50 contacts the outer peripheral surface of the base plate 30 so as to form the gap X1. Further, the second tubular portion 52 of the cover bracket 50 is in slide contact with the gear plate 40 so as to form the gap X2. The first tubular portion 51 is coupled to the outer periphery of the base plate 30 by laser welding from the outer periphery side (see the arrow “a” in FIG. 5), thereby fixing the cover bracket 50 to the base plate 30. As a result, the base plate 30 and the gear plate 40 are held by the cover bracket 50 in the state where relative rotation therebetween is allowed and relative movement therebetween in the axial direction is regulated.

After the reclining manipulation lever 23 is assembled with the center shaft 22 that is inserted into the through-hole 71 of the cam 70, the reclining apparatus 20 depicted in FIG. 2 is completed. In the reclining apparatus 20 structured as described above, the projections 30b of the base plate 30 are engaged into the corresponding engagement holes in the lower bracket 11a. Further, the projections of the gear plate 40 are engaged into the corresponding engagement holes in the upper bracket 12a. As a result, the reclining apparatus 20 couples the seat cushion 11 and the seat back 12 tiltably relative to each other. The base plate 30 may be mounted to the upper bracket 12a, and the gear plate 40 may be mounted to the lower bracket 11 a.

The unlocked state and the locked state of the reclining apparatus 20 structured as described above according to this embodiment are described below.

### (Unlocked State)

First, the unlocked state of the reclining apparatus 20 is described.

For adjustment of an inclination angle of the seat back 12, an occupant brings the reclining apparatus 20 into the unlocked state. Accordingly, the occupant manipulates the reclining manipulation lever 23 to rotate the center shaft 22 in the unlocking rotation direction. This allows the cam 70 to rotate in the unlocking rotation direction together with the center shaft 22 against the biasing force of the spring members 80.

The rotation of the cam 70 in the unlocking rotation direction releases the contact between the cam surface 72 of the cam 70 and the rear end faces of the lock gears 61 and 62. As a result, the biasing force of the cam 70 that outwardly biases the lock gears 61 and 62 in the radial direction disappears. This allows the lock gears 61 and 62 to inwardly move in the radial direction. Accordingly, the internal gears 41 of the gear plate 40 is releasable from engagement with the external gears 61a and 62a of the respective lock gears 61 and 62.

The lever plate 90 is rotated together with the cam 70 in the unlocking rotation direction, thereby bringing the inner peripheral edges of the cam holes 92 and 93 in the lever plate 90 into contact with the corresponding projections 61 b of the lock gears 61 or the corresponding projections 62b of the lock gears 62. This allows the lock gears 61 and 62 to inwardly move in the radial direction. As a result, the internal gears 41 are released from engagement with the external gears 61 a and 62.

As described above, after releasing the internal gears 41 from engagement with the external gears 61 a and 62a, the gear plate 40 becomes freely rotatable. As a result, the round reclining unit 21 enters the unlocked state. When the round reclining unit 21 enters the unlocked state, the reclining apparatus 20 also enters the unlocked state. This allows the occupant to freely adjust the inclination angle of the seat back 12.

### (Locked State)

Next, the locked state of the reclining apparatus 20 is described.

Upon completing the adjustment of the inclination angle of the seat back 12, the occupant brings the reclining apparatus 20 into the locked state. Accordingly, the occupant loosens the reclining manipulation lever 23. As a result, the cam 70 is rotated in the locking rotation direction by the biasing force of the spring members 80.

The cam surface 72 of the rotating cam 70 comes into contact with the rear end faces of the lock gears 61 and 62. This allows the lock gears 61 and 62 to be outwardly biased in the radial direction. As a result, the external gears 61a of the lock gears 61 and the external gears 62a of the lock gears 62 outwardly move in the radial direction and mesh with the internal gears 41 of the gear plate 40.

The external gears 61a of the lock gears 61 and the external gears 62a of the lock gears 62 mesh with the internal gears 41 of the gear plate 40, thereby limiting the rotation of the gear plate 40. As a result, the reclining apparatus 20 enters the locked state.

As described above, in the reclining apparatus 20 according to this embodiment, the annular protruding portion 33 is formed at the outer edge of the base plate 30. The inner peripheral surface of the annular protruding portion 33 is formed to be engageable with the outer peripheral surface of the gear plate 40. The cover bracket 50 is fixed to the base plate 30. The end face 51a of the first tubular portion 51 of the cover bracket 50 on the first side in the axial direction is located closer to the second side in the axial direction than the mounting surface 30a (see the gap X1 in FIG. 5). The cover bracket 50 is fixed to the base plate 30 by welding the first tubular portion 51 to the base plate 30 by laser welding from the outer periphery side.

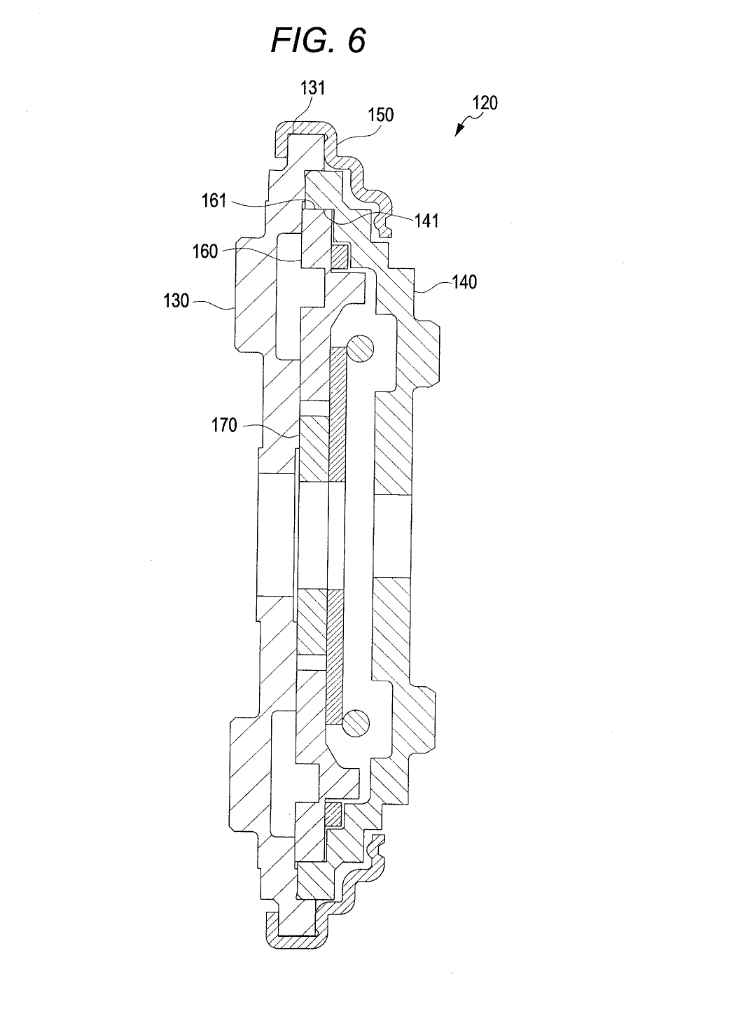

Thus, in the reclining apparatus 20, the cover bracket 50 is fixed by welding to the outer periphery of the base plate 30. Hence, the held portion 131 (see FIG. 6) for fixing the cover bracket 50 does not have to be provided to the outer peripheral portion of the base plate 30. Accordingly, the radial dimension of the reclining apparatus 20 can be reduced. Further, the welded portion is located on the outer periphery side, and the end face 51a of the first tubular portion 51 on the first side in the axial direction is located closer to the second side in the axial direction than the mounting surface 30a. This structure enables avoidance of the welded portion and the first tubular portion 51 from being hit against the lower bracket 11 a mounted on the mounting surface 30a.

Consequently, a compact reclining apparatus with a small radial dimension is achieved.

In the reclining apparatus 20 according to this embodiment, the gap X2 is formed between the end face 33a of the annular protruding portion 33 on the second side in the axial direction and the cover bracket 50. Further, the annular protruding portion 33 is formed by plastic working. This leads to a reduction in dimensional accuracy desired for the annular protruding portion 33. Therefore, plastic working, such as ironing, which enables formation of the protruding portion at low cost, may be employed as a method for forming the annular protruding portion 33, although the processing accuracy is relatively lowered.

The reclining apparatus according to this embodiment may also be embodied as follows.

That is, the method for welding the first tubular portion 51 to the base plate 30 from the outer periphery side is not limited to laser welding. For example, other welding methods such as spot welding and seam welding may also be employed.

Further, the method for forming the annular protruding portion 33 is not limited to ironing, and other plastic working or other forming methods such as cutting may also be employed. In the case of employing a forming method enabling forming of the annular protruding portion 33 at high accuracy, there is no need to form a gap between the end face 33a of the annular protruding portion 33 on the second side in the axial direction and the second tubular portion 52.

Furthermore, the seat slide device according to this embodiment may also be expressed as first and second seat slide devices as described below. That is, the first seat slide device is a reclining apparatus for adjusting a tilt angle between a first member and a second member to be tilted relative to each other, the reclining apparatus including: a base plate mounted to the first member through a mounting surface on a first side in an axial direction; a gear plate including an internal gear, the gear plate being mounted to the second member and assembled with the base plate rotatably relative to each other; a cover that holds the base plate and the gear plate rotatably relative to each other in the state where the cover contacts the base plate through an inner surface of a first tubular portion and is in slide contact with the gear plate through an inner surface of a second tubular portion, the cover being configured to suppress a relative movement between the base plate and the gear plate in the axial direction; a lock gear including an external gear meshable with the internal gear, the lock gear being assembled with a guide portion formed on the base plate so as to be guided movably in a radial direction; and a cam configured to allows the external gear to mesh with the internal gear by controlling movement of the lock gear to an outside in the radial direction. A protruding portion that protrudes in an annular manner in the axial direction toward a second side in the axial direction is formed at an outer edge of the base plate such that the inner peripheral surface thereof is engageable with the outer peripheral surface of the gear plate; the first tubular portion is formed such that an end face on the first side in the axial direction is located closer to the second side in the axial direction than the mounting surface in the state where the cover is fixed to the base plate; and the first tubular portion is coupled to the base plate by welding from the outer periphery side to fix the cover to the base plate.

In the first reclining apparatus, the second reclining apparatus is a reclining apparatus in which a gap is formed between the end face of the protruding portion on the second side in the axial direction and the cover, and the protruding portion is formed by plastic working.

In the first reclining apparatus, a protruding portion that protrudes in an annular manner in the axial direction toward the second side in the axial direction is formed at an outer edge of the base plate such that the inner peripheral surface thereof can be engaged with the outer peripheral surface of the gear plate. The first tubular portion of the cover is formed such that the end face on the first side in the axial direction is located closer to the second side in the axial direction than the mounting surface in the state where the cover is fixed to the base plate. Further, the first tubular portion is coupled to the base plate by welding from the outer periphery side to fix the cover to the base plate.

Thus, in the first reclining apparatus, the cover is fixed by welding to the outer periphery of the base plate. Hence, the held portion for fixing the cover does not have to be provided to the outer peripheral portion of the base plate. Accordingly, the radial dimension of the reclining apparatus can be reduced. Further, the welded portion is located on the outer periphery side and the end face on the first side in the axial direction of the first tubular portion of the cover is located closer to the second side in the axial direction than the mounting surface. This structure obviates hitting of the welded portion and the first tubular portion against the first member mounted on the mounting surface.

Consequently, a compact reclining apparatus with a small radial dimension is achieved.

In the second reclining apparatus, the gap is formed between the end face of the protruding portion on the second side in the axial direction and the cover. Further, the protruding portion is formed by plastic working. Thus, the gap is formed between the end face of the protruding portion on the second side in the axial direction and the cover. This leads to a reduction in dimensional accuracy desired for the protruding portion. Therefore, plastic working, such as ironing, which enables formation of the protruding portion at low cost, may be employed as a method for forming the protruding portion, although the processing accuracy is relatively lowered.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A reclining apparatus for adjusting a tilt angle between a first member and a second member, comprising:
a base plate mounted to the first member;
a gear plate mounted to the second member and assembled with the base plate rotatably relative to each other;
a gear mechanism for controlling engagement of the gear plate with the base plate; and
a cover having a first tubular portion fixed to an outer periphery of the base plate and a second tubular portion in slide contact with an outer periphery of the gear plate, the cover being configured to allow the base plate and the gear plate to rotate relative to each other and to suppress a relative movement therebetween in an axial direction, wherein
the first tubular portion is coupled by welding to the outer periphery of the base plate.

2. The reclining apparatus according to claim 1, wherein a first gap is formed between an end face of the cover on a side of the base plate of the first tubular portion, and a mounting surface for mounting the first member of the base plate.

3. The reclining apparatus according to claim 1, further comprising:
an annular protruding portion on an outer periphery of the base plate, wherein
the annular protruding portion is engageable with an outer peripheral surface of the gear plate, and
the first tubular portion is fixed to the protruding portion.

4. The reclining apparatus according to claim 3, wherein a second gap is formed between a leading end of the protruding portion and the cover.

5. The reclining apparatus according to claim 4, wherein the protruding portion is formed by plastic working.

6. The reclining apparatus according to claim 1, wherein
the gear plate includes an internal gear, and
the reclining apparatus further comprises:
a lock gear including an external gear meshable with the internal gear, the lock gear being assembled with a guide portion of the base plate movably in a radial direction; and
a cam for controlling an outward movement of the lock gear in the radial direction to control meshing of the external gear with the internal gear.

7. A vehicle seat comprising the reclining apparatus according to claim 1.
